(19) United States
(12) Patent Application Publication
(10) Pub. No.: US 2013/0141384 A1
(43) Pub. Date: Jun. 6, 2013

(54) COMMUNICATION BETWEEN TOUCH SENSITIVE DEVICES USING THE HUMAN BODY AS A CONDUIT

(71) Applicant: Debanjan MUKHERJEE, San Jose, CA (US)

(72) Inventor: Debanjan MUKHERJEE, San Jose, CA (US)

(21) Appl. No.: 13/312,711

(22) Filed: Dec. 6, 2011

(51) Int. Cl. G06F 3/044

(52) U.S. Cl. 345/174

(57) ABSTRACT

Touch sensitive devices and processes for communicating between touch sensitive devices are disclosed. A capacitive touch sensitive device can be configured to communicate with a neighboring touch sensitive device by driving one or more drive lines or electrodes of the device's touch sensor with a communication signal. The communication signal can be transmitted to the neighboring touch sensitive device through the body of a user in contact with both devices. The neighboring device can receive the communication signal from the body of the user using the sense lines or electrodes of its touch sensor. The communication signal can include identification information of the device that can be used by the neighboring device to wirelessly pair with the device.

### FIELD

This relates generally to touch sensitive devices and, more specifically, to communication between touch sensitive devices.

### BACKGROUND

Touch sensitive devices, such as track pads, touch sensitive displays, and the like, have become popular as input devices to computing systems due to their ease and versatility of operation as well as their declining price. Some touch sensitive devices can be wirelessly coupled, or “paired,” with other devices to allow one or two way communication between the devices. For example, a wireless track pad can be paired with a desktop computer, allowing inputs on the track pad to be received by the desktop computer.

While device pairing provides users with flexibility in the devices that can be used together, the pairing process can be tedious and time consuming. For example, a typical pairing process requires a user to put one of the devices to be paired into a “discoverable” mode. The user must then select an option on a base device to cause the base device to search for discoverable neighboring devices. Once the base device detects one or more discoverable neighboring devices, the user must then select the specific device that they would like to pair with the base device.

### SUMMARY

Touch sensitive devices and processes for communicating between touch sensitive devices are disclosed. A capacitive touch sensitive device can be configured to communicate with a neighboring touch sensitive device by driving one or more drive lines or electrodes of the device's touch sensor with a communication signal. The communication signal can be transmitted to the neighboring touch sensitive device through the body of a user in contact with both devices. The neighboring device can receive the communication signal from the body of the user through the sense lines or electrodes of its touch sensor. The communication signal can include identification information of the device that can be used by the neighboring device to wirelessly pair with the device.

### BRIEF DESCRIPTION OF THE DRAWINGS

FIG. 1 illustrates an exemplary touch sensor that can be used for device-to-device communication according to various embodiments.

FIG. 2 illustrates an exemplary system having devices configured to communicate using a touch sensor according to various embodiments.

FIG. 3 illustrates an exemplary process for communicating between touch sensitive devices according to various embodiments.

FIG. 4 illustrates an exemplary process for establishing a communication link between touch sensitive devices according to various embodiments.

FIG. 5 illustrates an exemplary process for establishing a communication link between touch sensitive devices according to various embodiments.

FIG. 6 illustrates an exemplary system configured to communicate using a touch sensor according to various embodiments.

FIG. 7 illustrates an exemplary personal device configured to communicate using a touch sensor according to various embodiments.

FIG. 8 illustrates an exemplary personal device configured to communicate using a touch sensor according to various embodiments.

FIG. 9 illustrates an exemplary personal device configured to communicate using a touch sensor according to various embodiments.

FIG. 10 illustrates an exemplary personal device configured to communicate using a touch sensor according to various embodiments.

### DETAILED DESCRIPTION

In the following description of example embodiments, reference is made to the accompanying drawings in which it is shown by way of illustration specific embodiments that can be practiced. It is to be understood that other embodiments can be used and structural changes can be made without departing from the scope of the various embodiments.

This relates to touch sensitive devices and processes for communicating between touch sensitive devices. A capacitive touch sensitive device can be configured to communicate with a neighboring touch sensitive device by driving one or more drive lines of the device's touch sensor with a communication signal. The communication signal can be transmitted to the neighboring touch sensitive device through the body of a user in contact with both devices. The neighboring device can receive the communication signal from the body of the user though the sense lines of its touch sensor. The communication signal can include identification information of the device that can be used by the neighboring device to wirelessly pair with the device.

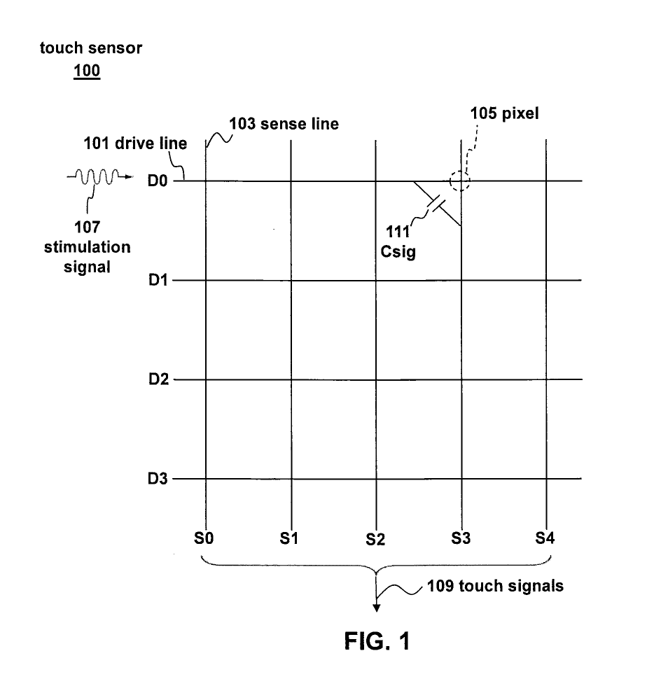

FIG. 1 illustrates capacitive touch sensor 100 that can be used to detect touch events on a touch sensitive device, such as a mobile phone, tablet, touchpad, portable computer, portable media player, track pad, or the like. Touch sensor 100 can include an array of pixels 105 that can be formed at the crossing points between rows of drive lines 101 (D0-D3) and columns of sense lines 103 (S0-S4). Each pixel 105 can have an associated mutual capacitance Csig 111 formed between the crossing drive lines 101 and sense lines 103 when the drive lines are stimulated. The drive lines 101 can be stimulated by stimulation signals 107 provided by drive circuitry (not shown) and can include an alternating current (AC) waveform. The sense lines 103 can transmit touch signals 109 indicative of a touch at the touch sensor 100 to sense circuitry (not shown), which can include a sense amplifier for each sense line, or in alternative embodiments, fewer sense amplifiers than sense lines, with the sense amplifiers selectively configurable to couple to the sense lines using circuits such as multiplexers.

To sense a touch at the touch sensor 100, drive lines 101 can be stimulated by the stimulation signals 107 to capacitively couple with the crossing sense lines 103, thereby forming a capacitive path for coupling charge from the drive lines 101 to the sense lines 103. The crossing sense lines 103 can output touch signals 109, representing the coupled charge or current. When a user's finger (or other object) touches the touch sensor 100, the finger can cause the capacitance Csig 111 to reduce by an amount ΔCsig at the touch location. This capacitance change ΔCsig can be caused by charge or current from the stimulated drive line 101 being shunted through the touching finger to ground rather than being coupled to the crossing sense line 103 at the touch location. The touch signals 109 representative of the capacitance change ΔCsig can be transmitted by the sense lines 103 to the sense circuitry for processing. The touch signals 109 can indicate the pixel where the touch occurred and the amount of touch that occurred at that pixel location.

While the embodiment shown in FIG. 1 includes four drive lines 101 and five sense lines 103, it should be appreciated that touch sensor 100 can include any number of drive lines 101 and any number of sense lines 103 to form the desired number and pattern of pixels 105. Additionally, while the drive lines 101 and sense lines 103 are shown in FIG. 1 in a crossing configuration, it should be appreciated that other configurations are also possible to form the desired pixel pattern. While various embodiments describe a sensed touch, it should be appreciated that the touch sensor 100 can also sense a hovering object and generate hover signals therefrom.

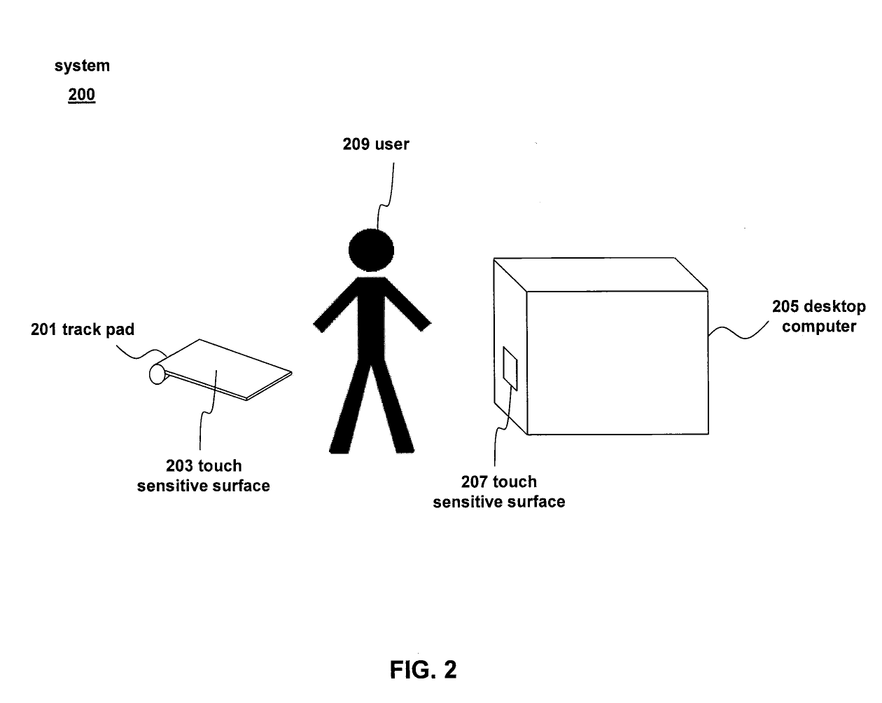

FIG. 2 illustrates an exemplary system 200 having devices configured to communicate with each other using their respective capacitive touch sensors. System 200 can include a first device, such as track pad 201, having a touch sensor similar or identical to touch sensor 100 used to detect touch events on touch sensitive surface 203. While track pad 201 is provided as an example of the first device, it should be appreciated that the first device can be any device having a touch sensor similar or identical to touch sensor 100. For example, the first device can be a wireless mouse, wireless keyboard, tablet computer, cellular phone, media player, or the like. Even devices that traditionally do not include touch sensors can be used. For example, a touch sensor can be incorporated within a desktop computer for the purpose of allowing the desktop to be paired with another device having a touch sensor.

System 200 can further include a second device, such as desktop computer 205. Since desktop computers traditionally do not include a touch sensor, a touch sensor similar or identical to touch sensor 100 can be added to desktop computer 205 to create touch sensitive surface 207. As will be described in greater detail below, touch sensitive surface 207 can be used by desktop computer 205 to communicate with track pad 201. While desktop computer 205 is provided as an example of the second device, it should be appreciated that the second device can be any device having a touch sensor similar or identical to touch sensor 100. For example, the second device can be a wireless mouse, wireless keyboard, tablet computer, cellular phone, or the like.

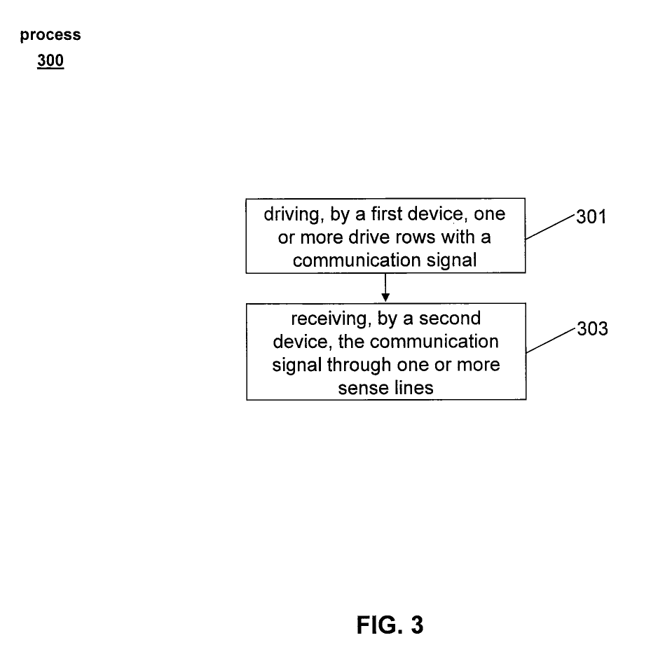

FIG. 3 illustrates an exemplary process 300 for communicating between touch sensitive devices. At block 301, a first device can drive one or more drive rows of its touch sensor with a communication signal. For example, referring to FIG. 2, track pad 201 can drive one or more of its drive rows with a communication signal. The communication signal can be similar or identical to the stimulation signal (e.g., stimulation signal 107) used to detect touch events and can be generated by the same or different circuitry as the drive circuitry used to generate the stimulation signal. In some embodiments, the communication signal can be modulated to include information to be sent to another device.

In some embodiments, to distinguish the communication signal from the stimulation signal, the communication signal can be configured to have a different frequency than the stimulation signal. For example, the stimulation signal can have a frequency between 100 to 1000 KHz and the communication signal can have a data rate between 1 to 10 Kbits/sec. However, it should be appreciated that other frequencies can be used. Additionally, the amplitude of the communication signal can be the same or different than the amplitude of the stimulation signal. One of ordinary skill in the art can determine parameters for the communication signal that will produce a detectible signal at a receiving device for a given application.

At block 303, a second device can receive the communication signal through one or more sense lines of its touch sensor. In some embodiments, the communication signal can be transmitted from the first device to the second device through the body of a user. For example, referring to FIG. 2, user 209 can contact both touch sensitive surface 203 of track pad 201 and touch sensitive surface 207 of desktop computer 205, thereby establishing a path between the devices through which the communication signal can travel. In these embodiments, the communication signal generated by the first device (e.g., track pad 201) can travel through the body of the user (e.g., user 209) to the second device (e.g., desktop computer 205), causing a detectible signal at the sense lines of the second device. The detected signal can then be processed by the second device to extract the information contained in the communication signal. In some embodiments, since the location on the touch sensitive surface that the user contacts does not matter when receiving the communication signal, the second device can add the sensed signals received from each sense line to increase the strength of the received signal.

In some embodiments, for the second device to detect the communication signal from the first device, the second device can enter a listening mode in which no stimulation signal or communication signal is being driven on the drive lines of the second device. As a result, any signal detected by the sense lines can be attributed to a communication signal received from another device.

In some embodiments, process 300 can be used for one-way communication from the first device to the second device. In these embodiments, process 300 can be used to transmit data, such as documents, photos, and the like, from the first device to the second device. In other embodiments, process 300 can be used for two-way communication between the first device and the second device by also configuring the second device to transmit a communication signal to the first device using process 300. In these embodiments, handshaking protocols can be used to transmit data between the devices.

While process 300 was described above using a user's body as a conduit for the communication signal between the first device and the second device, other options are possible. For instance, in some embodiments, more than one human body can be used to transmit the communication signal from the first device to the second device. For example, a first user can contact the touch sensitive surface of a first device and shake hands with a second user contacting the touch sensitive surface of a second device. Information, such as a business card, can be transmitted from the first device to the body of the first user, from the body of the first user to the body of the second user, and from the body of the second user to the second device. In other embodiments, the touch sensitive surfaces of the first and second devices can be placed against each other to enable communication between the devices. For example, the touch sensitive surface of a first cell phone can be placed against the touch sensitive surface of a second cell phone to allow data to be exchanged between the devices. In this example, the drive lines of the first device can be close enough to the sense lines of the second device to capacitively couple with the sense lines of the second device such that the communication signal generated by the first device can cause a detectible signal to be generated in the sense lines of the second device. In other alternative embodiments, a conductive element, such as a wire placed in close proximity to the touch sensitive surfaces of both the first and second devices, can be used instead of the user's body. Additionally, conductive elements coupled to the first device, but not necessarily in close proximity to the touch sensitive surface of the first device, can be used as the conductive element. For example, earbuds or the like plugged into the first device can pick-up the communication signal generated within the first device, and act as an antenna such that when placed in close proximity to the touch sensitive surface of the second device, provide the conduit for communications between the two devices.

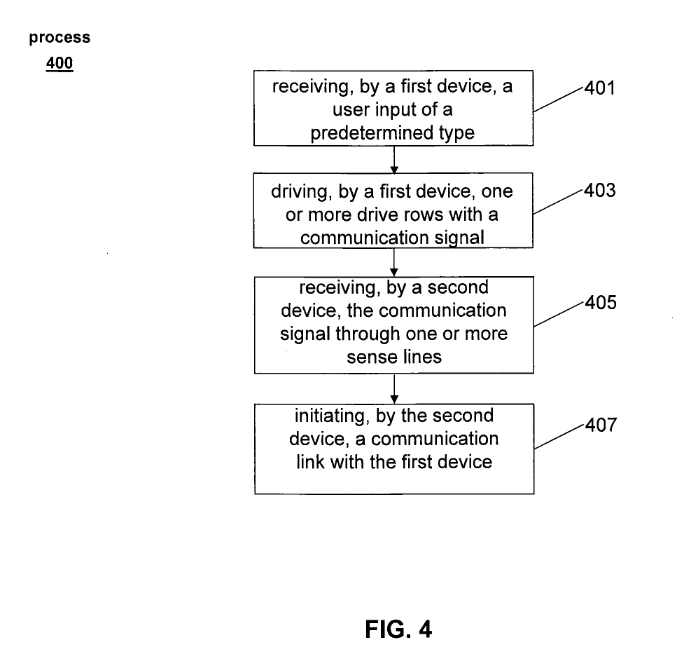

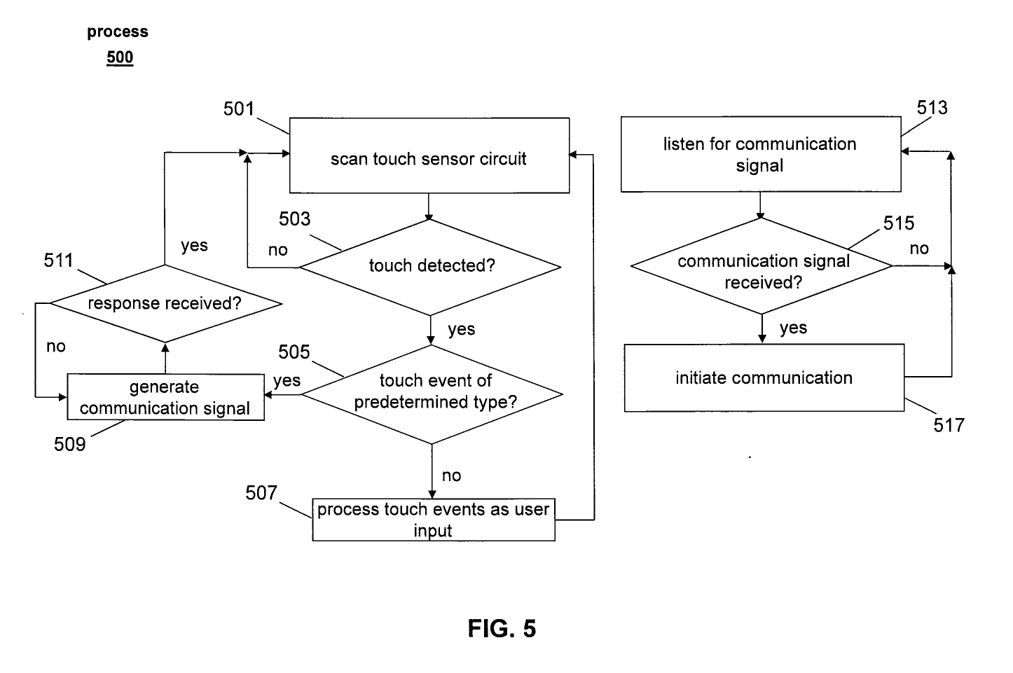

Additionally, while process 300 was described above using specific examples, it should be appreciated that process 300 can be used to communicate any type of information between devices having touch sensitive surfaces. For example, FIGS. 4-5 illustrate exemplary processes 400 and 500 that utilize process 300 to establish a communication link between devices having touch sensitive surfaces.

Specifically, FIG. 4 illustrates an exemplary process 400 for establishing a communication link between touch sensitive devices. At block 401, a first device can receive a user input of a predetermined type. For example, track pad 201 can receive a touch event of a predetermined type from user 209. The touch event of a predetermined type can include any desired user input. For example, in some embodiments, the touch event of a predetermined type can include three fingers applied to the touch sensitive surface of the first device (e.g., touch sensitive surface 203), four fingers applied to the touch sensitive surface of the first device, a palm of a hand applied to the touch sensitive surface of the first device, or the like.

At block 403, in response to receiving the user input of a predetermined type at block 401, the first device can drive one or more of its drive rows with a communication signal in a manner similar or identical to block 301 of process 300. In some embodiments, the communication signal can include identification information of the first device. For example, the communication signal can carry a unique identification of the first device that can be used by other devices to establish a communication link with the first device.

At block 405, a second device can receive the communication signal sent by the first device. Block 405 can be similar or identical to block 303 of process 300. For example, a second device, such as desktop computer 205, can receive the communication signal generated by a first device, such as track pad 201. In some embodiments, the communication signal can be transmitted from the first device to the second device through the body of a user touching both devices. For example, a user can cause a touch event of a predetermined type at the first device, triggering the generation of the communication signal by the first device, and can also contact the touch sensitive surface of the second device, thereby establishing a communication path between the first and second devices.

In some embodiments, the communication signal can be detected by the second device using the sense lines of the second device's touch sensor. As mentioned above, the communication signal can have frequency that is different than the frequency of the stimulation signal. Thus, based on the frequency of the signals detected on the sense lines, the second device can determine if the detected signal is a stimulation signal or a communication signal. Additionally, in some embodiments where the communication signal includes an identification of the first device, the second device can extract this information from the communication signal.

At block 407, the second device can initiate a communication link with the first device. For example, in some embodiments, the second device can initiate a wireless communication link (e.g., a Bluetooth pairing or the like) with the first device using the first device's identification information contained in the communication signal. While Bluetooth pairing is provided as an example, it should be appreciated that other communication protocols can be used.

Using process 400, a user can intuitively cause the first device to be paired with the second device by contacting the touch sensitive surfaces of each device. This obviates the need to put one device in a “discoverable” mode while searching for the discoverable device using a base device as is required by conventional pairing processes.

FIG. 5 illustrates an exemplary process 500 that can be performed by the first and/or second device when performing process 400. At block 501, the device (the first and/or second device) can scan its touch sensor to detect touch events. For example, the device can drive its drive lines with a stimulation signal similar or identical to stimulation signal 107. In some embodiments, depending on the device, the scan of the touch sensor can take between 8-16 ms. Approximately half of the scan time can be used to drive the drive lines with the stimulation signal while the remaining time can be used to process the signals received on the sense lines. While specific time values are provided above, it should be appreciated that other scan durations can be used.

At block 503, it can be determined if a touch event was detected during the scan of the touch sensor performed at block 501. If no touch event was detected, then the process can return to block 501 where the device can again scan the touch sensor circuit for touch events. If, however, it is determined at block 503 that a touch event has been detected, then the process can proceed to block 505.

At block 505, it can be determined if the touch event is of a predetermined type. For example, in some embodiments, the predetermined types of touch events can include one or more of three fingers applied to the touch sensitive surface of the device, four fingers applied to the touch sensitive surface of the device, a palm of a hand applied to the touch sensitive surface of the device, or the like. If the detected touch event is not of a predetermined type, the process can proceed to block 507. At block 507, the detected touch event can be processed and interpreted as a normal user input (e.g., a click, scroll, drag, zoom, or the like). The process can then return to block 501. If, however, it is determined at block 505 that the detected touch event is of a predetermined type, the process can proceed to block 509.

At block 509, a communication signal can be generated in a manner similar or identical to block 301 of process 300. For example, in some embodiments, drive circuitry can drive the drive lines of the device with a communication signal. As mentioned above, the communication signal can have a frequency that is different than the frequency of the stimulation signal. Additionally, the communication signal can include identification information of the device.

As the device drives the drive lines with the communication signal, the process can proceed to block 511 where it can be determined if a communication has been received in response to the communication signal. For example, in some embodiments, when a second device receives the communication signal from a first device, the second device can send a communication to the first device in an attempt to wirelessly pair with the device. The communication from the second device can include identification information of the second device and any additional information required to pair the devices. In other embodiments, the communication from the second device can be received by the sense lines of the first device. If, at block 511, it is determined that no communication has been received in response to the communication signal generated at block 509, the process can return to block 509 where the communication signal can continue to be driven on the drive lines of the device. If, however, it is determined that a communication has been received in response to the communication signal generated at block 509, the device can cease generation of the communication signal and can return to block 501 where the device can again scan the touch sensor to detect touch events.

In some embodiments, in addition to returning to block 501 when a response is received at block 511, the process can also return to block 501 when the touch event of the predetermined type is no longer detected. For example, the process can repeatedly perform blocks 509 and 511 while waiting for a communication in response to the generated communication signal. However, if the device detects that the touch event of the predetermined type (e.g., three fingers, four fingers, a palm of a hand, or the like) has been removed, the device can stop generating the communication signal and can return to block 501 regardless of whether or not a communication is received from another device.

Process 500 can further include block 513 that can be performed at the same or at a different time than blocks 501, 503, 505, 507, 509, and 511. At block 513, the device can listen for a communication signal (e.g., a communication signal generated by driving the drive lines of another device with the communication signal) sent from another device. As mentioned above, in some embodiments, the scanning of the touch sensor to detect touch events performed at block 501 can take between 8-16 ms. Approximately half of that time can be used to drive the drive lines with the stimulation signal while the remaining time can be used to process the signals received on the sense lines. Thus, in some embodiments, the device can listen for a communication signal during some or all of the time normally used for processing. Specifically, since the device's drive lines may not be driven with a stimulation signal during the processing period, any signal detected by the sense lines during this time can be determined to have originated from another device. The frequency and duration of the listening performed at block 513 can be performed at any desired interval. For example, in some embodiments, the device can listen for the communication signal for approximately 1 ms, 2 ms, 3 ms, or any other desired duration every 20 ms, 30 ms, 50 ms, or any other desired duration. It can be desirable to set the frequency and duration of the listening so that the user cannot detect a noticeable delay when attempting to establish a communication link between two devices.

At block 515, it can be determined if a communication signal has been received. If it is determined that no communication signal has been received, the process can return to block 513. If, however, it is determined that a communication signal has been received, the process can proceed to block 517.

At block 517, the device can initiate communication with a device that sent the communication signal. In some embodiments, block 517 can be similar or identical to block 407 of process 400. For example, in some embodiments, a second device can extract a device identification from the communication signal sent by a first device and can initiate a wireless communication with the first device. Using the device identification in the communication signal, the second device can initiate a Bluetooth pairing with the first device. In other embodiments, other types of wireless communications can be established between the devices. In yet other embodiments, the second device can communicate with the first device by driving the drive lines of the second device with a response communication signal. This response communication signal can be received by the first device using the sense lines of the first device. Once communication is established between the devices, the process can return to block 513 where the device can listen for communication signals.

It should be appreciated that blocks 513, 515, and 517 can be performed at any time. For example, a non-predetermined type of touch event can be detected at blocks 501, 503, and 505 that is to be interpreted as a normal user input. However, if a communication signal is received by the device during the processing of the touch event, the device can proceed through blocks 513, 515, and 517. As blocks 513, 515, and 517 are being performed, the functions of blocks 501, 503, 505, 507, 509, and 511 can be stopped. In some embodiments, once block 517 is performed, the process can return to blocks 501 and 513.

In some embodiments, a device can perform all blocks of process 500. For example, a device, such as track pad 201, can perform blocks 501, 503, 505, 509, and 511 to detect when a user wants to pair the device with another device. Additionally, track pad 201 can perform blocks 501, 503, 505, and 507 to process touch events as user input when the device is being used as an input device for another device (e.g., desktop computer 205). Track pad 201 can also perform blocks 513, 515, and 517 to initiate communication with another device in response to receiving a communication signal from the other device.

In other embodiments, a device can perform only a subset of the blocks of process 500. For example, a device having a touch sensor for the purpose of communicating with other devices, such as desktop computer 205, can only perform blocks 501, 503, 505, 509, 511, 513, 515, and 517. Desktop computer 205 can perform blocks 501, 503, 505, 509, and 511 to detect when a user wants to pair the device with another device. Desktop computer 205 can also perform blocks 513, 515, and 517 to initiate communication with another device in response to receiving a communication signal from the other device. However, desktop computer 205 may not perform block 507 since touch sensitive surface 207 may not be used to receive normal user input (e.g., a click, scroll, drag, zoom, or the like).

In other embodiments, a device can be designated as a device that generates a communication signal but does not listen for communication signals or initiate wireless communication with other devices. In these embodiments, the device can perform blocks 501, 503, 505, 509, 511, and can optionally perform block 507 if the device is used to receive normal user input. In other embodiments, a device can be designated as a device that listens for communication signals and initiates communication (e.g., wireless communication) with other devices. In these embodiments, the device can perform

The quality of the communication signal received by a device can depend on the grounding of the user coupling the devices together. If the user is well grounded, the signal strength can be weaker. If the user is poorly grounded, the signal strength can be stronger. Thus, in some embodiments, the device generating the communication signal and/or the device receiving the communication signal can be configured to detect the grounding condition of the user using techniques known to those of ordinary skill in the art. Examples of techniques for detecting the grounding condition of a user can be found in U.S. patent application Ser. No. 12/558,380 and U.S. patent application Ser. No. 12/500,870. Based on the detected grounding condition, the device can increase the strength of the communication signal (the transmitting device) or increase the sensitivity of the sense circuitry (the receiving device) in response to detection of a well grounded user and can decrease the strength of the communication signal (the transmitting device) or decrease the sensitivity of the sense circuitry (the receiving device) in response to detection of a poorly grounded user.

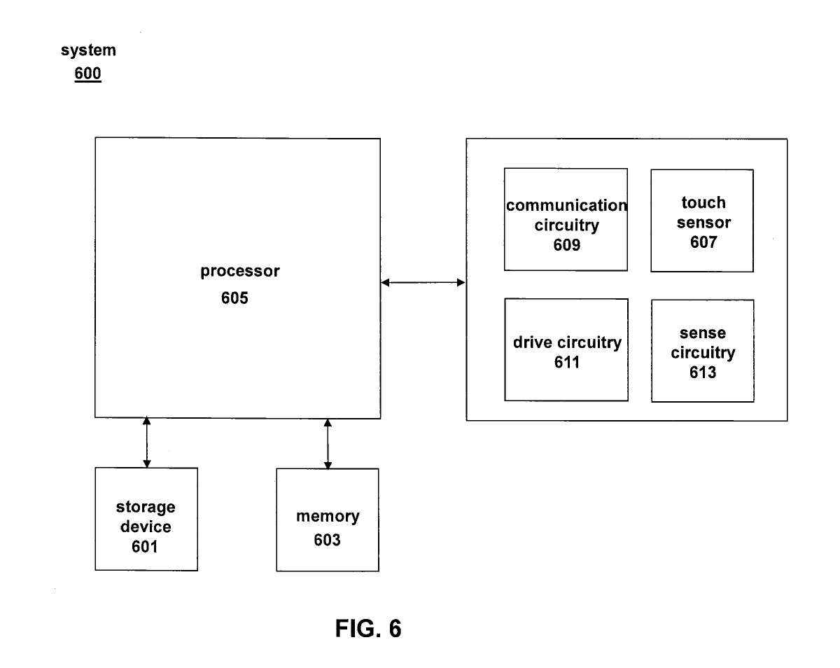

One or more of the functions relating to the communication between devices using a touch sensor can be performed by a system similar or identical to system 600 shown in FIG. 6. System 600 can include instructions stored in a non-transitory computer readable storage medium, such as memory 603 or storage device 601, and executed by processor 605. The instructions can also be stored and/or transported within any non-transitory computer readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “non-transitory computer readable storage medium” can be any medium that can contain or store the program for use by or in connection with the instruction execution system, apparatus, or device. The non-transitory computer readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The instructions can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any medium that can communicate, propagate or transport the program for use by or in connection with the instruction execution system, apparatus, or device. The transport medium can include, but is not limited to, an electronic, magnetic, optical, electromagnetic or infrared wired or wireless propagation medium.

System 600 can further include touch sensor 607 coupled to processor 605. Touch sensor 507 can be similar or identical to touch sensor 100, described above. System 600 can further include drive circuitry 611 coupled to processor 605 and configured to generate communication signals and stimulation signals similar or identical to stimulation signals 107. System 600 can further include sense circuitry 613 coupled to processor 605 and configured to detect touch events or communication signals received by the sense lines of touch sensor 607. System 600 can further include communication circuitry 609 coupled to processor 605 and configured to communication with other devices. For example, communication circuitry 609 can include wireless communication circuitry, such as Bluetooth circuitry, Processor 605 can control touch sensor 607, communication circuitry 609, drive circuitry 611, and sense circuitry 613 to operate as described above with respect to processes 300 , 400, and 500.

It is to be understood that the system is not limited to the components and configuration of FIG. 6, but can include other or additional components in multiple configurations according to various embodiments. Additionally, the components of system 600 can be included within a single device, or can be distributed between multiple devices.

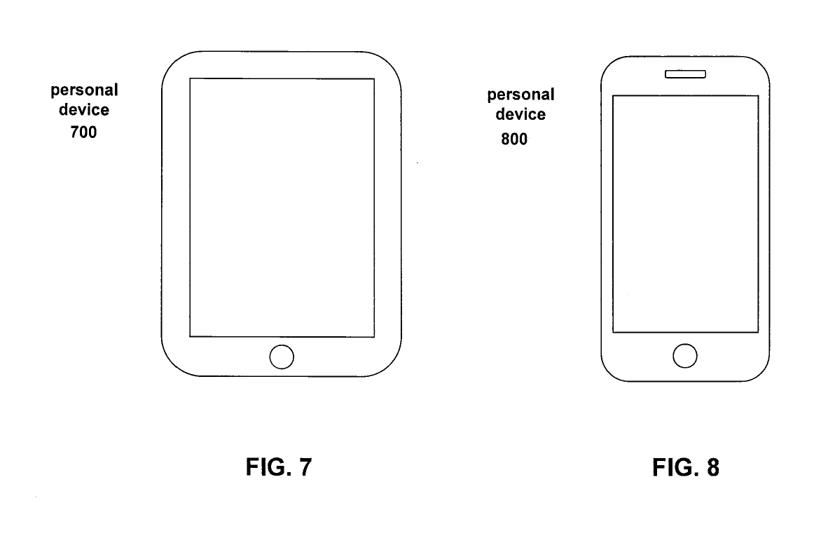

FIG. 7 illustrates an exemplary personal device 700, such as a tablet, that can be configured to communicate using a touch sensor according to various embodiments.

FIG. 8 illustrates another exemplary personal device 800, such as a mobile phone, that can be configured to communicate using a touch sensor according to various embodiments.

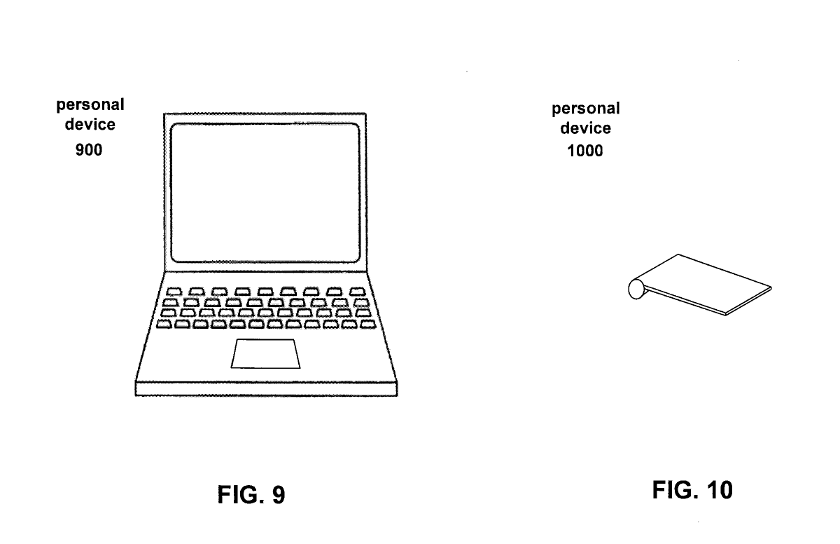

FIG. 9 illustrates another exemplary personal device 900, such as a laptop computer, that can be configured to communicate using a touch sensor according to various embodiments.

FIG. 10 illustrates another exemplary personal device 1000, such as a track pad, that can be configured to communicate using a touch sensor according to various embodiments.

While specific devices are provided above as examples of devices that can be configured to communicate using a touch sensor, it should be appreciated that any device having a touch sensor, such as a keyboard, mouse, or the like, can be configured to communicate using their respective touch sensors according to various embodiments.

Although embodiments have been fully described with reference to the accompanying drawings, it is to be noted that various changes and modifications will become apparent to those skilled in the art. Such changes and modifications are to be understood as being included within the scope of the various embodiments as defined by the appended claims.

What is claimed is:

1. A method for communicating between touch sensitive devices, the method comprising:
driving one or more drive rows of a first touch sensitive device with one or more drive signals;
monitoring one or more sense lines capacitively coupled to the one or more drive rows for a touch event on the first touch sensitive device; and
driving the one or more drive rows with one or more communication signals upon detection of a predetermined type of touch event.

2. The method of claim 1, wherein the predetermined type of touch event comprises one or more of a three-finger touch event, four-finger touch event, or palm of a hand touch event.

3. The method of claim 1, wherein a frequency of the one or more drive signals is different than a frequency of the one or more communication signals.

4. The method of claim 1 further comprising:
receiving a wireless communication signal from a second touch sensitive device; and
stopping, by the first touch sensitive device, the driving of the one or more drive rows with the one or more communication signals upon receiving the wireless communication signal.

5. The method of claim 4, wherein the communication signal is transmitted from the first touch sensitive device to the second touch sensitive device through a body of a user contacting the first touch sensitive device and the second touch sensitive device.

6. The method of claim 5 further comprising:
determining a grounding condition of the user; and
adjusting a strength of the one or more communication signals based on the determined grounding condition of the user.

7. A method for communicating between touch sensitive devices, the method comprising:
monitoring one or more sense lines of a first touch sensitive device for one or more communication signals; and
receiving, through the body of a user, the one or more communication signals from a second touch sensitive device.

8. The method of claim 7 further comprising initiating a wireless communication link with the second touch sensitive device upon receiving the one or more communication signals.

9. The method of claim 8, wherein the wireless communication link comprises a Bluetooth communication link.

10. The method of claim 7, wherein during the monitoring of the one or more sense lines of the first touch sensitive device, no stimulation signal is driven on one or more drive lines of the first touch sensitive device.

11. The method of claim 7 further comprising extracting information associated with the second touch sensitive device that is included in the communication signal.

12. A method for communicating between touch sensitive devices, the method comprising:
periodically driving one or more drive rows of a first touch sensitive device with one or more stimulation signals; and
periodically monitoring one or more sense lines of the first touch sensitive device for one or more communication signals from a second touch sensitive device.

13. The method of claim 12, wherein a frequency of the driving of the one or more drive rows of the first touch sensitive device with one or more stimulation signals is less than a frequency of the monitoring the one or more sense lines of the first touch sensitive device for the one or more communication signals.

14. The method of claim 12 further comprising monitoring the one or more sense lines of the first touch sensitive device for one or more touch signals generated in response to the stimulation signal.

15. The method of claim 14 further comprising determining if the one or mores touch signal represent a touch event of a predetermined type.

16. The method of claim 14 further comprising driving the one or more drive rows of the first touch sensitive device with one or more communication signals upon determining that the touch signal represents the touch event of the predetermined type.

17. A touch sensitive device comprising:
a plurality of drive rows;
a plurality of sense lines capacitively coupled to the plurality of drive rows; and
drive circuitry configured to:
drive the plurality of drive rows with one or more stimulation signals; and
drive the plurality of drive rows with one or more communication signals.

18. The touch sensitive device of claim 17 further comprising sense circuitry coupled to the plurality of sense lines and configured to:
receive one or more touch signals from the plurality of sense lines, the touch signals generated in response to the stimulation signals; and
receive one or more communication signals generated by a neighboring touch sensitive device and received through the body of a user.

19. The touch sensitive device of claim 18, wherein the drive circuitry is configured to drive the plurality of drive rows with the one or more communication signals in response to the sense circuitry receiving one or more touch signals representing a touch event of a predetermined type.

20. The touch sensitive device of claim 18 further comprising wireless communication circuitry configured to communicate with the neighboring touch sensitive device.

21. The touch sensitive device of claim 20, wherein the wireless communication circuitry is configured to initiate a wireless communication link with the neighboring touch sensitive device in response to the sense circuitry receiving the one or more communication signals generated by the neighboring touch sensitive device.

22. A touch sensitive device comprising:
a capacitive touch sensor; and
sense circuitry coupled to the capacitive touch sensor, the sense circuitry configured to receive one or more communication signals generated by a neighboring touch sensitive device.

23. The touch sensitive device of claim 22 further comprising wireless communication circuitry configured to initiate a wireless communication link with the neighboring touch sensitive device in response to the sense circuitry receiving the one or more communication signals generated by the neighboring touch sensitive device.

24. The touch sensitive device of claim 23, wherein the one or more communication signals comprises a unique identification of the neighboring touch sensitive device, and wherein the wireless communication circuitry is configured to initiate the wireless communication link with the neighboring touch sensitive device using the unique identification.

25. The touch sensitive device of claim 22, wherein the sense circuitry is configured to receive the one or more communication signals through a body of a user, and wherein the sense circuitry is further configured to receive one or more touch signals from the capacitive touch sensor, the one or more touch signals representative of one or more touch events detected by the capacitive touch sensor.
